(19) United States
(12) Patent Application Publication
(10) Pub. No.: US 2012/0076317 A1
(43) Pub. Date: Mar. 29, 2012

(54) MEDIA PLAYER SYSTEM WITH ANTI-VOICE OPERATED SWITCH

(75) Inventors: Roger A. Fratti, Berks County, PA (US); Cathy L. Hollien, Somerset County, NJ (US)

(73) Assignee: LSI Corporation

(21) Appl. No.: 12/888,668

(22) Filed: Sep. 23, 2010

(51) Int. Cl. H04R 1/10

(52) U.S. Cl. 381/74; 381/122

(57) ABSTRACT

A media player system and method includes a microphone, a hearing appliance, a converter, a flash memory, a comparing unit, a timer, and a switching unit (e.g., anti-voice operated switch). The microphone associated with a squelch control unit receives and samples an external sound as a user listens to a media file via the hearing appliance. The converter digitizes the external sound and the comparing unit compares the digitized sound with one or more keywords stored in the flash memory. The switching unit automatically temporarily mutes the audio stream for a predetermined time period thereby enabling the user to hear the external sound.

### TECHNICAL FIELD

Embodiments are generally related to portable media players. Embodiments are also related to anti-voice operated switching techniques. Embodiments are additionally related to media player system that is responsive to an external sound.

### BACKGROUND OF THE INVENTION

A PMP (Portable Media Player) is a consumer electronics device that is capable of storing and playing digital media such as, for example, data indicative of audio, images, video, documents, etc. A PMP can be connected to a hearing appliance (e.g., a headphone) to permit a user to listen to music content in a personalized high fidelity manner. Such a hearing appliance acoustically isolates a user from the external environment in order to provide a serene audio environment of personally played music.

Unfortunately, such acoustic isolation with respect to the user may completely obliterate a sound signal from the external environment. For example, a user of the PMP may be unable to hear a person communicating with him or her due to the music playing through the headphones. Similarly, the headphone-wearing media player user may not hear a warning sound such as, for example, a siren or an alarm, thus creating a dangerous situation for the user.

Based on the foregoing, it is believed that a need exists for an improved media player system with an anti-voice operated switch that is responsive to an external sound for a predetermined time period, as described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved portable media player.

It is another aspect of the disclosed embodiments to provide for an improved media player system with an anti-voice operated switch that is responsive to an external sound.

It is a further aspect of the disclosed embodiments to provide for an improved method for temporarily muting an audio stream associated with the media player.

The aforementioned aspects and other objectives and advantages can now be achieved as described herein. A media player system is disclosed which includes a microphone, a hearing appliance, a converter, a flash memory, a comparing unit, a timer, and a switching unit (e.g., anti-voice operated switch). The microphone associated with a squelch control unit receives and samples an external sound as a user listens to a media file via the hearing appliance. The converter digitizes the external sound and the comparing unit compares the digitized sound with one or more keywords stored in the flash memory. The switching unit automatically and temporarily mutes the audio stream for a predetermined time period thereby enabling the user to hear the external sound.

The squelch control unit located on the microphone generally captures the external sound signals by eliminating an undesired noise and/or disturbances within an environment. The squelch control unit controls operation of the converter in order to save the power consumption with respect to the media player. The switching unit includes a timer for permitting the external sounds that match the keywords into the hearing appliance for the predetermined time period. The volume can be automatically muted for the predefined period of time in response to a user-defined keyword or a standard keyword captured from the external environment. The user defined keyword can be, for example, a media player user name and the standard keyword can be, for example, a “help” or “emergency” keyword captured from the external environment. An audio input can be digitized and stored into the flash memory in a calibration mode that can be employed as the user defined keyword. Such an external sound responsive portable media player system intelligently mutes the audio stream to the user based on the detected sounds from the external environment.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a media player system having an anti-voice operated switch, in accordance with the disclosed embodiments;

FIG. 2 illustrates a circuit diagram of the anti-voice operated switch, in accordance with the disclosed embodiments; and

FIG. 3 illustrates a high level flow chart of operations illustrating logical operational steps of a method for muting an, audio stream associated with the media player for a predetermined time period, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

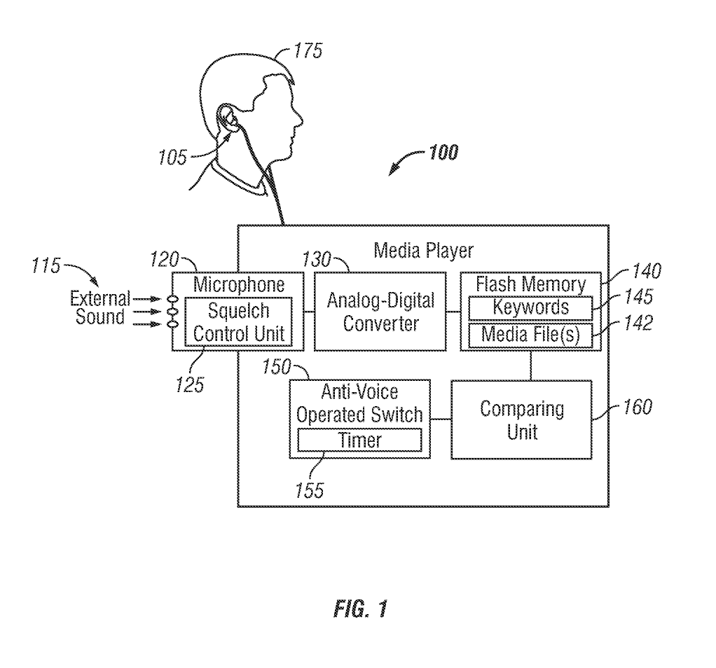

FIG. 1 illustrates a block diagram of a media player system 100 having an anti-voice operated switch 150, in accordance with the disclosed embodiments. The portable media player system 100 intelligently mutes a media file 142 to a user 175 based on at least one detected sound from an external environment. Note that the media player system 100 disclosed herein can be, for example, an MP3 player, a cell phone, a personal digital assistant (PDA), and the like. The media player system 100 can be employed to perform functions such as, for example, playing/broadcasting media, downloading, and recording the media files 142. The media player 100 generally includes a microphone 120, a converter 130, a flash memory 140, a comparing unit 160, and the anti-VOX switch 150 with a timer 155 and the hearing appliance 105.

The media player system 100 decodes the media files 142 into an audio signal and outputs the audio signals via the hearing appliance 105 for the user 175 to listen. The hearing appliance 105 disclosed herein can be such as, for example, an ear phone, a headphone, and the like. The media player 100 receives and samples an external sound 115 via the microphone 120 associated with a squelch control unit 125 as the user 175 listens to the media file 142 via the hearing appliance 105. The microphone 120 can be an acoustic-to-electric transducer and/or sensor that receive and convert the external sound 115 into an electrical signal. The microphone 120 detects the external sound 115 from the user's local external environment. The microphone 120 can be incorporated within the casing of the portable media player system 100 or may be remotely located elsewhere upon the body of the user 175 and is connected to the media player 100 by a wired or wireless link.

The squelch control unit 125 samples the external sound 115 by eliminating undesired noise and/or disturbances within the environment. The external sound 115 from the microphone 120 can be generally captured as analog audio signals and converted to digital form by the converter 130 or other similar component and/or process. Note that the converter 130 can be an analog to digital converter for providing digital signal representing the external sound 115 to the comparing unit 160 of the media player system 100. Note that the microphone 120 is local to the hearing appliance 105 of the user 175. In some embodiments, the microphone 120 can be interfaced to the media player 100 by a Bluetooth communication link. In some embodiments, the microphone 120 includes a number of microphone elements.

The squelch control unit 125 controls operation of the converter 130 in order to save the power consumption with respect to the media player system 100. The comparing unit 160 compares the external sound 115 with one or more keywords 145 stored in the flash memory 140. Note that the term “media file” refers to video, audio, streaming and any combination thereof. In addition, the media player system 100 can be envisioned to optionally include features such as graphic equalization, volume, balance, fading, base and treble controls, surround sound emulation, and noise reduction. However, it will be apparent to those skilled in the art that other features can be utilized as desired without departing from the scope of the invention.

The flash memory 140 of the media player 100 is a built-in non-volatile memory that stores the keywords 145 along with the media files 142 such as music files, image files, and the like in a read/write compatible format. The keywords 145 stored into the flash memory 140 can be a user defined keyword that includes a personal identifier of the user and/or an emergency signal. The keywords 145 stored into the flash memory 140 can be a standard keyword such as, for example, a “help” or “emergency” keyword captured from the external environment. An audio input can be digitized and stored into the flash memory 140 in a calibration mode, to be used as the user defined keywords 145. The flash memory 140 stores the media files 142 corresponding to multiple music pieces based on the storage capacity of the flash memory 140 and the directory information indicating configurations of the stored media files 142.

The comparing unit 160 compares the external sound 115 with the stored keywords 145 while the media player 100 is running in a working mode. The switching unit 150 includes the timer 155 for permitting the external sounds 115 that match the keywords 145 into the hearing appliance 105 for a predetermined time period. The switching unit 150 automatically and temporarily mutes audio stream with respect to the media player system 100 (for the predetermined time period) thereby enabling the user 175 to hear the external sound 115.

The volume can be automatically muted for the predefined time period in response to the media player user name being detected as a verbal content within the audio signal captured from the external environment. The volume can be automatically muted for the predefined period of time in response to an alarm sound or siren sound being detected as within the audio signal captured from the external environment. For example, the media player 100 records the speech of a parent in the calibration mode in order to mute the media player 100 when the parent yells for the child. The media player 100 further recognizes an emergency signal such as the ‘Help’ keyword in order to alert emergency personnel (e.g., police officials) with respect to an emergency situation.

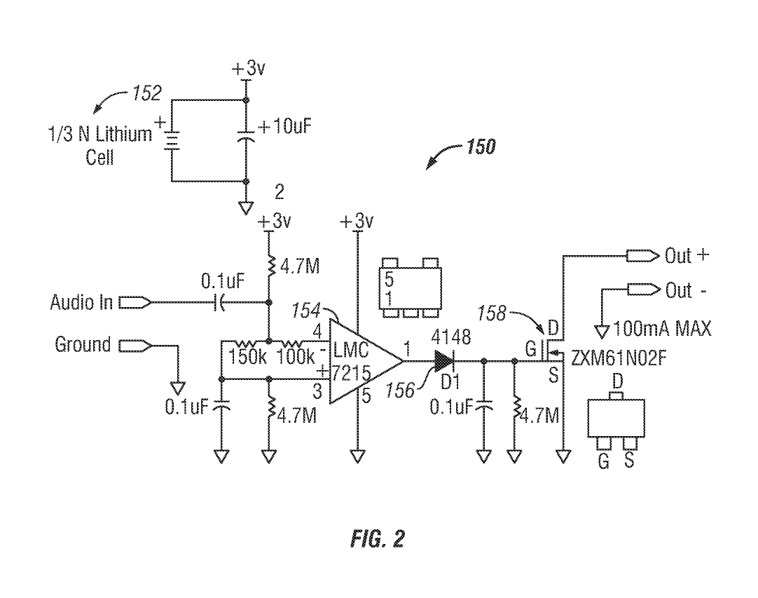

FIG. 2 illustrates a circuit diagram of the voice operated switch (VOX-switch) 150, in accordance with the disclosed embodiments. Note that in FIGS. 1-3, identical parts or elements are generally indicated by identical reference numerals. The universal voice-operated-switch 150 associated with the media player 100 can be employed in a wide range of voice based recognition applications. The circuit 150 typically includes a lithium battery cell 152, an operational amplifier 154, a diode 156, and a field effect transistor (FET) 158 for receiving an input signal (Audio In) from an external environment and executes one or more processing operations in order to generate the output signal. The lithium battery 152 can be widely employed in product consumer electronic devices such as the media player 100 for producing voltages (approximately 3v) in the circuit.

In general, the operational amplifier 154 is a high-gain electronic voltage amplifier that produces an output signal with larger voltage difference between the input audio signals. The diode 156 associated with the switching circuit 150 is a two-terminal electronic component that conducts electric current in one direction. The field effect transistor 158 relies on an electric field to control the shape and hence the conductivity of a channel of one type of charge carrier in a semiconductor material. The VOX switch 150 operatively connected with the comparing unit 160 turns on by recognizing the syllable of the predetermined keyword 145 and mutes the media stream of the media player 100 on detecting the voice energy threshold. The VOX switch 150 may also be virtually coupled with any microphone 120 in order to directly switch any low voltage load up to 100 mA. The VOX switch 150 in association with the converter 130, the flash memory 140, the comparing unit 160, and the timer 155 can be employed to control the media player such as, MP3 player and/or any other device in response to the external sound 115 for the predetermined time period. The VOX switch 150 plays the external sound 115 by temporarily muting the audio stream of the media file 142 in order to alert the user 175 to respond in an emergency situation.

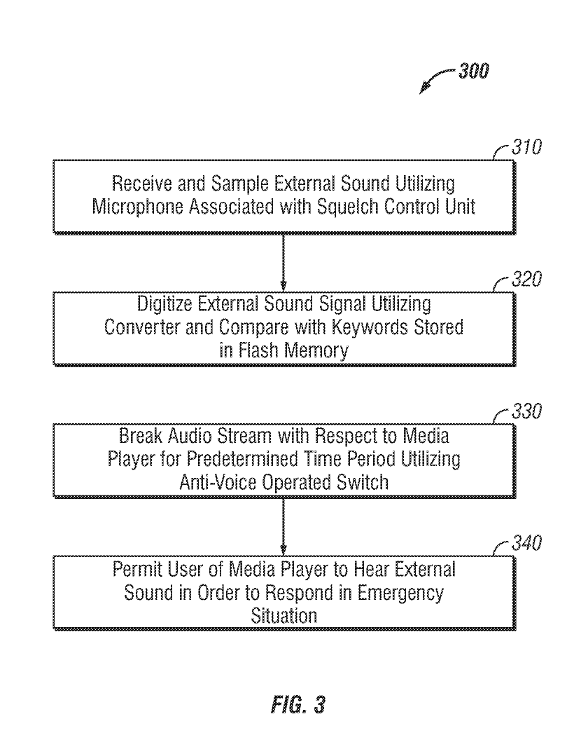

FIG. 3 illustrates a high level flow chart of operations illustrating logical operational steps of method 300 for muting an audio stream associated with the media player 100 for a predetermined time period (e.g., temporarily muting the audio stream), in accordance with the disclosed embodiments. The external sound 115 can be received and sampled, via the microphone 120 associated with the squelch control unit 125, as illustrated at block 310. The external sound 115 can be digitized utilizing the converter 130 and compared with the keywords 145 stored in the flash memory 140, as depicted at block 320. The audio stream with respect to the media player 100 can be temporarily muted for the predetermined time period utilizing the anti-VOX switch 150, as indicated at block 330. The user 175 can be permitted to hear the external sound 115 in order to respond in the emergency situation, as illustrated at the block 340. Such an external sound responsive portable media player system 100 intelligently mutes the audio stream to the user based on the detected sounds from the external environment.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A media player system, comprising:
a microphone that includes a squelch control unit for receiving and sampling an external sound from an environment as a user listens to a media file via a hearing appliance;
a converter for digitizing said external sound, wherein said converter communicates electronically with said squelch control unit;
a comparing unit for comparing said external sound with at least one keyword, wherein said comparing unit communicates electronically with said converter and said squelch control unit; and
a switching unit for temporarily muting an audio stream associated with said media file in order to enable said user to hear said external sound, wherein said switching unit communicates electronically with said converter, said squelch control unit and said comparing unit.

2. The system of claim 1 further comprising a timer that permits said external sound to pass into said hearing appliance for said predetermined time period when it is determined said external sound matches said at least one keyword.

3. The system of claim 1 further comprising a flash memory for storing said at least one keyword by digitizing an audio input in a calibration mode.

4. The system of claim 1 wherein said at least one keyword comprises at least one of the following types of keywords:
a standard keyword; and
a user-defined keyword.

5. The system of claim 1 wherein said squelch control unit controls operations of said convertor in order to conserve an operating power associated with said media player system.

6. The system of claim 1 wherein said switching unit comprises an anti-voice operated switch.

7. The system of claim 1 wherein said converter comprises an analog to digital converter.

8. The system of claim 1 wherein said hearing appliance comprises at least one of the following types of appliances:
an ear phone;
a head phone; and
a helmet.

9. The system of claim 1 wherein said media player system comprises a digital audio player.

10. A media player system, comprising:
a microphone that includes a squelch control unit for receiving and sampling an external sound from an environment as a user listens to a media file via a hearing appliance;
a converter for digitizing said external sound, wherein said converter communicates electronically with said squelch control unit;
a comparing unit for comparing said external sound with at least one keyword, wherein said comparing unit communicates electronically with said converter and said squelch control unit;
a switching unit for temporarily muting an audio stream associated with said media file in order to enable said user to hear said external sound, wherein said switching unit communicates electronically with said converter, said squelch control unit and said comparing unit; and
a timer that permits said external sound to pass into said hearing appliance for said predetermined time period when it is determined said external sound matches said at least one keyword.

11. The system of claim 10 further comprising a flash memory for storing said at least one keyword by digitizing an audio input in a calibration mode.

12. A method for operating a media player system, said method comprising:
receiving and sampling an external sound from an environment via a squelch control unit as a user listens to a media file via a hearing appliance, said squelch control unit electronically associated with a microphone of said media player system;
automatically digitizing said external sound utilizing a converter electronically associated with said media player system, wherein said converter communicates electronically with said squelch control unit;
comparing said external sound with at least one keyword via a comparing unit electronically associated with said media player system, wherein said comparing unit communicates electronically with said converter and said squelch control unit; and
temporarily muting an audio stream associated with said media file utilizing a switching unit electronically associated with said medial player system in order to enable said user to hear said external sound, wherein said switching unit communicates electronically with said converter, said squelch control unit and said comparing unit.

13. The method of claim 12 further comprising permitting said external sound to pass into said hearing appliance for said predetermined time period via a timer electronically associated with said media player system, when it is determined said external sound matches said at least one keyword.

14. The method of claim 12 further comprising storing said at least one keyword in a flash memory by digitizing an audio input in a calibration mode.

15. The method of claim 12 wherein said at least one keyword comprises at least one of the following types of keywords:
a standard keyword; and
a user-defined keyword.

16. The method of claim 12 further comprising controlling operations of said convertor via said squelch control unit in order to conserve an operating power associated with said media player system.

17. The method of claim 12 wherein said switching unit comprises an anti-voice operated switch.

18. The method of claim 12 wherein said converter comprises an analog to digital converter.

19. The method of claim 12 wherein said hearing appliance comprises at least one of the following types of appliances:
an ear phone;
a head phone; and
a helmet.

20. The method of claim 12 wherein said media player system comprises a digital audio player.
